(19) United States
(12) Patent Application Publication
(10) Pub. No.: US 2026/0081701 A1
(43) Pub. Date: Mar. 19, 2026

(54) METHOD FOR DETERMINING PHASE INFORMATION RELATED TO AN RF TRANSMISSION CHANNEL AND RF DEVICE

(71) Applicant: Infineon Technologies AG, Neubiberg (DE)

(72) Inventors: Tobias BUCKEL, Bad Aibling (DE); Daniel REITER, München (DE); Andreas Sebastian OCH, Linz (AT); Jonas KAMMERER, Sauerlach (DE); Alexander BELITZER, München (DE); Dominik HUBER, München (DE); Gunther KRAUT, Egmating (DE); Thomas BRUDER, Grafing (DE); Simona-Maria STEFAN, Linz (AT)

(21) Appl. No.: 19/323,470

(22) Filed: Sep. 9, 2025

(30) Foreign Application Priority Data
Sep. 19, 2024 (DE) 102024209016.6
Feb. 3, 2025 (DE) 102025103747.7

(51) Int. Cl. H04B 17/10; H04B 17/12

(52) U.S. Cl. CPC H04B 17/101; H04B 17/12

(57) ABSTRACT

A method for determining phase information related to an RF transmission channel includes generating an RF signal, coupling a first representation of the RF signal to the RF transmission channel to generate an RF output signal, and coupling a second representation of the RF signal to a test phase shifter. Generating a down-converted signal based on mixing a representation of the RF output signal with each respective RF test signal of a set of RF test signals, sampling the down-converted signal to generate for each target phase shift value of a set of predetermined target phase shift values a respective measurement sample of a set of measurement samples. A set of non-uniformly distributed values is applied in an operation acting on a set of measurement samples to determine first-order harmonic information, and the phase information related to the RF transmission channel is determined based on the first-order harmonic information.

### CROSS-REFERENCE TO RELATED APPLICATIONS

This application claims priority to Germany Patent Application No. 102024209016.6 filed on Sep. 19, 2024, and Germany Patent Application No. 102025103747.7, filed on Feb. 3, 2025, the contents of which are incorporated by reference herein in their entirety.

### TECHNICAL FIELD

The present disclosure relates to RF devices.

### BACKGROUND

Radio frequency (RF) circuits in the range of 20 GHz and above are used in many applications today. For example, they are used to transmit data in accordance with modern communication protocols or to generate and transmit radar signals for detecting objects. In radar applications, the angle-resolved detection of objects requires the transmission of MIMO signals (MIMO=Multiple In Multiple Out) via several antennas, which can be achieved, for example, by different phase settings of the transmitted signals. In each of the above applications, it is desired to adjust the phase with high precision when transmitting the RF signals in order to avoid unwanted and detrimental effects. In radar applications, for example, an inaccurate phase setting of a transmission channel can lead to additional spectral components, which can significantly reduce the accuracy of angle detection. Providing precise phase settings require an internal phase measurements which may be performed in the background during operation.

Accordingly, there is a desire in the market for accurate internal phase measurements.

### SUMMARY

According to one aspect, a method for determining phase information related to an RF transmission channel includes generating an RF signal, coupling a first representation of the RF signal to the RF transmission channel to generate an RF output signal, and coupling a second representation of the RF signal to a test phase shifter. A set of measurement samples is generated based on setting a target phase shift setting of the test phase shifter to each target phase shift value of a set of predetermined target phase shift values to generate for each target phase shift value a respective RF test signal of a set of RF test signals, generating a down-converted signal based on mixing a representation of the RF output signal with each respective RF test signal of the set of RF test signals, sampling the down-converted signal to generate for each target phase shift value of the set of predetermined target phase shift values a respective measurement sample of the set of measurement samples. A set of non-uniformly distributed values is applied in an operation acting on the set of measurement samples to determine first-order harmonic information, and the phase information related to the RF transmission channel is determined based on the first-order harmonic information.

According to a further aspect, an RF device includes a local oscillator to generate an RF signal, an RF transmission channel configured to receive a first representation of the RF signal and to generate an RF output signal based on the first representation of the RF signal, a test phase shifter to receive a second representation of the RF signal, wherein the test phase shifter is configured to generate a set of RF test signals based on applying a phase shift to the second representation of the RF signal in accordance with a set of predetermined target phase shift values, and a mixer to generate a set of down-converted signals based on mixing a first representation of the RF output signal with each respective RF test signal of the set of RF test signals. A sampler is configured to sample each down-converted signal of the set of down-converted signals to generate for each target phase shift value of the set of target phase shift values a respective measurement sample of a set of measurement samples. A processing device is configured to apply, in an operation acting on the set of measurement samples, a set of non-uniformly distributed values to determine first-order harmonic information and to determine a phase information related to the RF transmission channel based on the first-order harmonic information.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 illustrates a schematic circuit diagram of an RF device according to an example.

FIG. 2A shows a diagram illustrating measurement samples for ideal and non-ideal phase settings according to an example.

FIG. 2B shows a diagram illustrating phase errors of a test phase shifter according to an example.

FIG. 2C shows a diagram illustrating a phase deviation between a calculated transmit phase information and an actual transmit phase.

FIG. 2D shows a diagram of phase deviations for multiple frequencies according to an example.

FIG. 3A shows a diagram of phase deviations for multiple frequencies according to an example.

FIG. 4 shows a flow chart diagram according to an example.

FIG. 5A shows a flow chart diagram according to an example.

FIG. 5B shows a process flow diagram according to an example.

FIG. 5C shows a process flow diagram according to an example.

FIG. 6 shows a diagram of phase deviations of a test phase shifter according to an example.

FIG. 7A shows a diagram of phase deviations of a transmit phase shifter according to a conventional calibration.

FIG. 7B shows a diagram of phase deviations of a transmit phase shifter according to an example.

### DETAILED DESCRIPTION

The examples described herein provide a new concept for determining phase information related to transmission channels. The new concept uses non-uniformly distributed values in an operation applied to a set of measurement samples achieving thereby more accurate phase information as will be described further below. The concept may be applied in a built-in phase measurement of transmission channels for calibration and monitoring of changes over operating conditions to ensure functional safety. It improves the performance of calibration and monitoring as inaccuracies resulting from the built-in phase measurement circuit itself can be reduced. A more accurate and robust target detection can be achieved therefore with improved angle resolution and reduction of spectral sidebands.

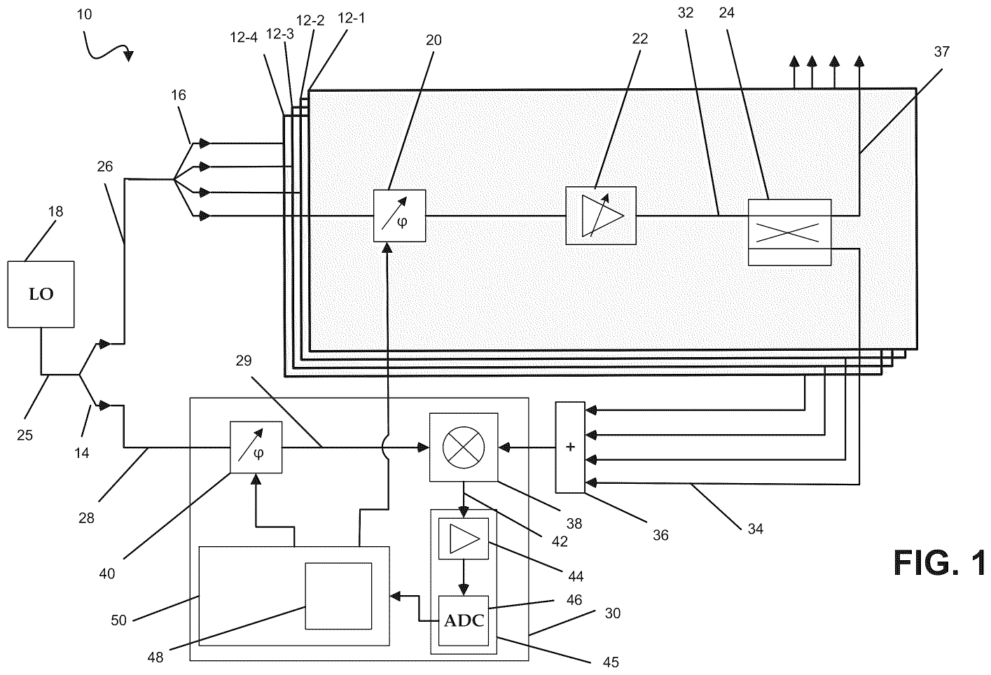

Referring to FIG. 1, a schematic circuit diagram of an RF device 10 according to an example is shown. The RF device 10 includes a plurality of transmission channels 12-1 to 12-4 for generating transmission signals. The RF device 10 may in one example be an MMIC semiconductor chip. Further functionalities such as receiving channels may be implemented in the RF device 10 but are omitted in FIG. 1 for the sake of clarity.

According to one example, the RF device 10 may be a radar device operating in a radar frequency range. In one example, the frequency range may be from 76 to 81 GHz, in a further example the frequency range may be from 21 GHz to 28 GHz. However, the present application is not restricted to these frequency ranges.

The RF device 10 includes a plurality of transmission channels 12-1 to 12-4. A local oscillator (LO) 18 is coupled via a first coupler 14 and a second coupler 16 to inputs of the transmission channels 12-1 to 12-4. The first coupler 14 and the second coupler 16 are implemented as splitters. The first coupler 14 and the second coupler 16 may be formed only by passive components to reduce influences on the phase. Each of the transmission channels 12-1 to 12-4 includes a phase shifter 20 (herein after referred to as transmission phase shifter or transmit phase shifter 20), a power amplifier 22 and a third coupler 24.

The local oscillator 18 is configured to generate a radio frequency signal (RF signal) 25. In some examples, the RF signal 25 maybe a continuous wave signal of fixed frequency. In other examples, the RF signal 25 may be a frequency modulated continuous wave signal (FMCW signal) including a chirp with a frequency ramp. In one example, the frequency ramp may be linear. The frequency of the frequency ramp may start at a start frequency and end at a stop frequency. The frequency ramp may be a rising ramp such that the frequency increases with time or a falling ramp such that the frequency decreases with time.

The RF signal 25 is split by the first coupler 14 in a first representation 26 of the RF signal 25 (herein referred to as transmission path signal 26) and a second representation 28 of the RF signal 25 (herein referred to as test path signal 28). The transmission path signal 26 and the test path signal 28 are replicas of the RF signal 25 and may have a reduced power level compared to the LO signal. The test path signal 28 is transferred to test circuitry 30 for providing at least one of a calibration functionality, a monitoring functionality or a testing functionality of the plurality of transmission channels 12-1 to 12-4. The test circuitry 30 will be described below in more detail.

The transmission path signal 26 is coupled to an input of the second coupler 16. The second coupler 16 couples the transmission path signal 26 into a respective transmission channel of the plurality of RF transmission channels 12-1 to 12-4. In other words, the first representation of the RF signal 25 is coupled to the input of the respective RF transmission channel via the first coupler 14 and the second coupler 16.

Each RF transmission channel of the plurality of the RF transmission channels 12-1 to 12-4 can be controlled to be activated or deactivated. Activating an RF transmission channel may for example include enabling the power amplifier 22 or disabling the power amplifier 22. During radar processing operation all or a subset of the RF transmission channels 12-1 to 12-4 may be activated, for example. During a monitoring mode of operation or a calibration mode of operation, only one of the plurality of RF transmission channels 12-1 to 12-4 may be activated.

An activated RF transmission channel processes the received input signal by applying a respective phase shift via the transmit phase shifter 20. A controller 50 is coupled to the transmit phase shifter 20 to set a target phase setting of the transmit phase shifter 20 during operation. The phase shifted RF transmit signal is amplified by the power amplifier 22 to generate an RF output signal 32.

The RF output signal 32 is transferred to an input of the third coupler 24 which couples a first representation 34 of the RF output signal 32 to an input of a combiner 36. A second representation 37 of the RF output signal 32 may be transmitted to an antenna port associated with the respective RF transmission channel. The second representation 37 of the RF output signal 32 may be a main portion of the RF output signal 32, e.g., the signal power of the second representation 37 of the RF output signal 32 may be higher than the signal power of the first representation 34 of the RF output signal 32.

The combiner 36 includes a plurality of inputs. Each of the plurality of inputs is associated with and coupled to a respective RF transmission channel of the plurality RF transmission channels 12-1 to 12-4. The combiner 36 couples the first representation 34 of the RF output signal 32 to a first input of a mixer 38 (herein referred to as test mixer 38) of the test circuitry 30.

The test circuitry 30 further includes a phase shifter 40 (herein referred to as a test phase shifter 40). An input of the test phase shifter 40 is coupled to an output of the first coupler 14 to receive the test path signal 28. The test phase shifter 40 applies a phase shift to the test path signal 28 in accordance with a target phase shift setting to generate an RF test signal 29. The test phase shifter 40 is coupled to the controller 50 to set the target phase shift setting of the test phase shifter to one of a set of predetermined target phase shift values.

In examples described herein, the test phase shifter 40 may be a passive phase shifter (PPS) using passive components such as capacitors, inductors or delay lines for applying a phase shift. The test phase shifter 40 may be configured to have a limited number of phase settings. It is to be noted that the limited number of phase settings of a passive phase shifter does typically not allow a pre-compensation of a phase error produced by the test phase shifter 40.

An output of the test phase shifter 40 is coupled to a second input of the test mixer 38 to transfer the RF test signal 29 to the test mixer 38. The test mixer 38 mixes the RF test signal 29 with the first representation 34 of the RF output signal 32 (herein also referred to as down-converting) to generate a down-converted signal 42. The down-converted signal 42 is provided to a sampler 45. The sampler 45 may include an amplifier 44 and an analog-to-digital converter (ADC) 46. In some examples, the amplifier 44 may be omitted. The sampler 45 generates a digital measurement sample from the down-converted signal 42.

The digital measurement sample is provided to a processing device 48. The processing device 48 is configured to compute phase information related to the respective RF transmission channel based on a set of digital measurement samples supplied to the processing device 48. The phase information related to the respective RF transmission channel may for example include a calculated phase of the RF output signal 32 relative to the phase of the RF signal 25 or relative to any other reference phase. The calculated phase of the RF output signal 32 may represent an estimate of the phase of the RF output signal 32 relative to the phase of the RF signal 25 or relative to any other reference phase.

For generating a set of measurement samples, the controller 50 sets a target phase shift setting of the test phase shifter 40 to each phase shift value of the set of predetermined target phase shift values while the phase shift applied by the transmit phase shifter 20 is not changed. For each target phase shift value of the set of predetermined target phase shift values, a measurement sample corresponding to the respective target phase shift value is generated resulting in the set of measurement samples.

According to one example, a measurement sample corresponding to a target phase shift value may be a selected single digital sample generated by the ADC 46 when the test phase shifter 40 is set to apply the target phase shift value. In other examples, a measurement sample may be a combination or average of multiple digital samples generated by the ADC 46 when the test phase shifter 40 is set to apply the respective target phase shift value.

The controller 50 and/or the processing device 48 may be implemented as hardware circuit, software, firmware or any combination thereof. The processing device 48 may for example include a Fourier transformation machine or a Goertzel filter to apply a discrete Fourier transformation operation and a programmable arithmetic logic unit or a digital processor capable of processing data or executing programming steps. The discrete Fourier Transformation may for example be a Fast Fourier Transformation (FFT). In some examples, the controller 50 and the processing device 48 may fully or partially utilize the same components. For example, the controller 50 may use the processing device 48 for performing control operations and calculating data.

In the following, details on the generating of the set of measurement samples and the calculation of the phase information related to the RF transmission channel will be described. It is assumed that the RF signal 25 is a continuous wave signal with constant frequency, however the considerations below can be applied in a similar manner to an RF signal 25 having a varying frequency, for example a frequency ramp.

Assuming a constant frequency of the RF signal 25, the RF test signal 29 can be described by

$${s}_{P P M} ( t ) = {A}_{1} \cdot cos ( 2 π {f}_{0} t + {φ}_{PPM} )$$

where s_{PPM}(t) is the RF test signal 29, A1 is the amplitude, t is the time, f₀ is the frequency, and φ_{PPM} is the phase shift in radians applied by the test phase shifter 40.

The first representation 34 of the RF output signal 32 can be described by

$${s}_{T X} ( t ) = {A}_{2} \cdot cos ( 2 π {f}_{0} ( t - τ ) + {φ}_{T X} )$$

where s_{TX}(t) is the first representation 34 of the RF output signal 32, A2 is the amplitude, t is the time, f₀ is the frequency, φ_{TX} is the phase shift applied by the transmit phase shifter 20 and τ represents the difference in arrival time (herein also referred to as RF delay time) between the signals s_{PPM}(t) and s_{TX}(t) at the test mixer 38. The difference in arrival time τ results for example from a signal delay caused by additional circuit components of the RF transmission channel or a difference in the length of signal lines.

After the mixing, the down-converted signal 42 is obtained as

$$s ( t ) = \frac{{A}_{1} \cdot {A}_{2}}{2} \cdot cos ( 2 π {f}_{0} τ + {φ}_{PPM} - {φ}_{T X} ) .$$

For a constant frequency of the RF signal 25, the down-converted signal 42 is a DC signal as it contains no time dependent term. The amplitude of the down-converted signal 42 is proportional to cos(2πf₀τ+φ_{PPM}−φ_{TX}). The term 2πf₀τ is a constant of small value and is typically the same for each transmit channel. In examples, phase stability and accuracy may be required only between the transmit channels, and the term 2πf₀τ can be neglected. The amplitude of the down-converted signal 42 then ends up to be proportional to cos(φ_{PPM}−φ_{TX}). The measurement sample which corresponds to the amplitude of the down-converted signal 42 is therefore also proportional to cos (φ_{PPM}−φ_{TX}).

Accordingly, the amplitude of the down-converted signal 42 depends on the actual phase shift φ_{PPM} applied by the test phase shifter 40 and on the actual phase shift φ_{TX} applied by the transmit phase shifter 20. To determine the transmit phase information for a specific setting of the transmit phase shifter 20 of the RF transmission channel, the phase shift applied to the test phase shifter 40 is varied by setting the target phase shift of the test phase shifter 40 to the plurality of target phase shift values while the phase setting of the transmit phase shifter 20 of the RF transmission channel is fixed.

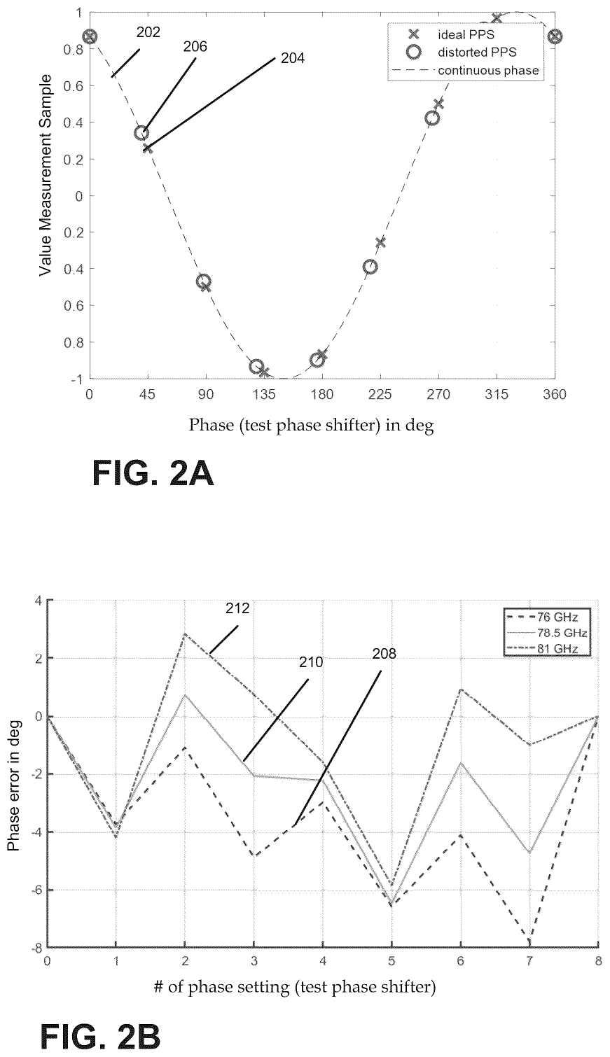

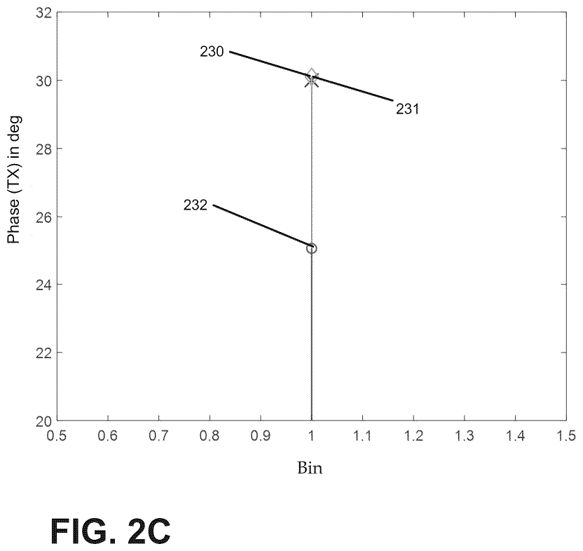

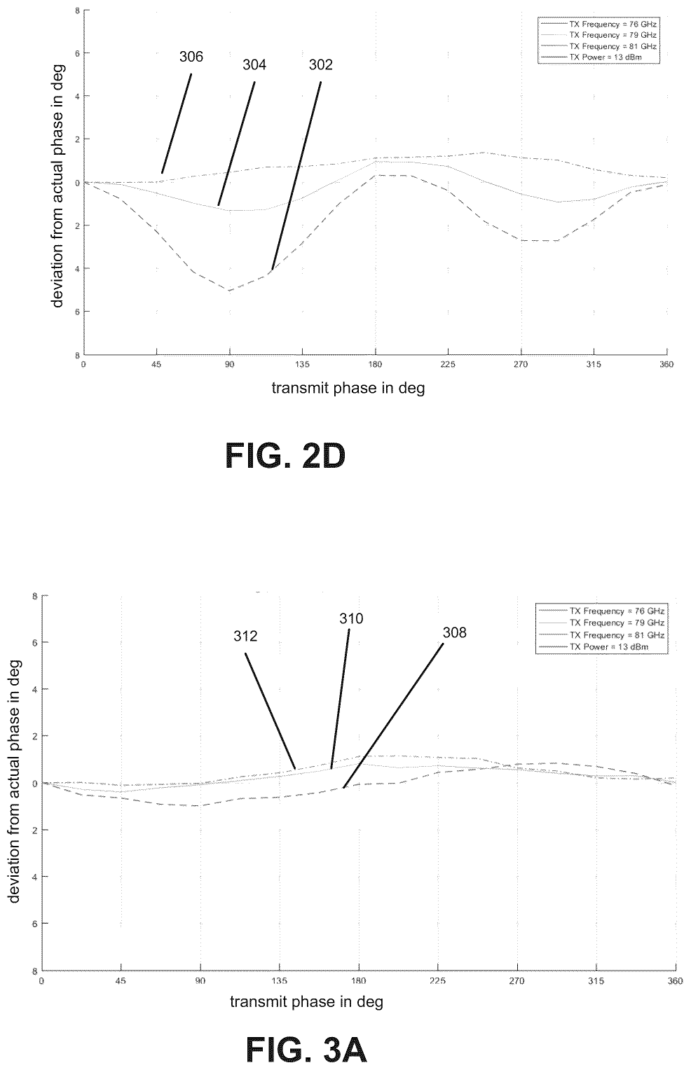

Referring now to FIG. 2A, an example of an actual applied phase shift of the test phase shifter 40 and the influence on the respective measurement samples is shown for an ideal and non-ideal test phase shifter 40. FIG. 2A shows as curve 202 an example of an amplitude of the down-converted signal 42 when the actual phase shift applied by the test phase shifter 40 is continuously varied. As outlined above, the amplitude of the down-converted signal 42 is proportional to cos(φ_{PPM}−φ_{TX}). Curve 202 is normalized to 1 and shows the function cos(φ_{PPM}−φ_{TX}) versus the phase shift φ_{PPM} applied by the test phase shifter 40. Curve 202 has a cosine shape according to cos(φ_{PPM}−φ_{TX}). As the argument of the cosine function is shifted by the phase shift φ_{TX} (in FIG. 2A by 30°) applied by the transmit phase shifter 20, the phase shift φ_{TX} can be determined therefrom.

In operation, however, the test phase shifter 40 is controlled to apply a set of discrete phase shifts in accordance with a set of discrete target phase shift values. The target phase shift values intended to be applied by the test phase shifter 40 are a set of discrete phase shift values which are typically uniformly distributed when represented on a unitary circle. FIG. 2A shows a set of measurement samples 204 (shown as crosses in FIG. 2A) corresponding to a set of eight equidistant target phase shift values (φ_{PPM}_target) from 0 to 360° applied to an ideal test phase shifter 40. The set of target phase shift values includes in this examples the values 0°, 45°, 90°, 135°, 180°, 225°, 270° and 315°. It is to be noted that 0 and 360° correspond to a same phase setting. While FIG. 2A shows eight target phase shift values, other numbers of target phase shift values may be applied in other examples. The number of target phase shift values may be N and the set of target phase shift values may contain the values from 0 to 360 n/N with n=0 to N−1 and N equal or greater than 2.

For the ideal test phase shifter 40, a phase shift value φ_{PPM} applied by the test phase shifter 40 is exactly the target phase shift value φ_{PPM}_target. Therefore, each measurement sample 204 corresponds to a point on the curve 202 exactly at the respective target phase shift value φ_{PPM}_target. Note that since the set of target phase values are selected to be uniformly, also the set of measurement samples is distributed uniformly (with respect to the abscissa). This allows to correctly determine the phase φ_{TX} by applying a discrete Fourier transformation on the measurement samples 204 with the uniformly distributed target phase shift values being the sample points for the discrete Fourier transformation.

In more detail, the first order harmonic bin value (corresponding to the fundamental wave component) of the discrete Fourier transformation result is used to calculate the phase φ_{TX}. The first order harmonic bin value is a complex-value and can be written as z1=Re(z1)+Im(z1), where Re is the real part of the complex-valued first order harmonic bin value and Im is the imaginary part of the complex-valued first order harmonic bin value. The phase φ_{TX} of the transmit signal can be derived by determining or estimating the inverse tangent of (Im(z1)/Re(z1)) or arctan 2(Im(z1),Re Im(z1)). The inverse tangent or arctan 2 can for example be estimated using a Cordic-implementation or using a processor capable of calculating or estimating the inverse tangent function.

In practice however, a phase shift applied by the test phase shifter 40 may deviate from the target phase shift value. Deviations may be caused for example due to variations during the manufacturing or temperature variations etc.

As a result, the applied phase shift values φ_{PPM} deviate from the target phase shift values and the set of applied phase shift values φ_{PPM} is non-uniformly distributed. An example of a non-uniform distribution of measurement samples 206 (shown as circles) is shown in FIG. 2A. Note that each of the measurement samples 206 still lies on curve 202. However the applied phases φ_{PPM} corresponding to the measurement samples 206 are no longer equally distributed due to the phase shift deviations of the test phase shifter 40.

The phase shift deviation introduced by the test phase shifter 40 may in addition have a frequency dependency as shown in FIG. 2B. FIG. 2B shows for each of the eight phase shift settings of FIG. 2A the introduced phase error for three different RF frequencies 76 GHz, 78.5 GHz and 81 GHz of the RF signal 25. Each of the frequencies has a specific phase deviation characteristic 208, 210 and 212 which is different form the characteristics of other frequencies.

Using the uniformly distributed target phase shift values as sample points (sometimes also referred to as mesh points or grid points) for the discrete Fourier transformation acting on the measurement samples 206 therefore introduces an error in the calculated phase shift φ_{TX}_calc due to the phase deviations of the non-ideal test phase shifter 40.

FIG. 2C shows an error of the phase information that is introduced by the non-uniform distribution of the applied phase shifts for the measurement samples 206 according to the example shown in FIG. 2A. FIG. 2C shows with reference sign 230 the correct phase φ_{TX}, in this case 30°. This value is also calculated using the Bin 1 result of a discrete Fourier transformation acting on the measurement samples 204 resulting from the ideal test phase shifter 40. With reference sign 232, the calculated phase φ_{TX}_calc resulting from the discrete Fourier transformation acting on the measurement samples 206 resulting from the non-ideal test phase shifter 40 is shown. It can be seen from FIG. 2C that the calculated phase φ_{TX}_calc 232 significantly deviates from the actual phase φ_{TX} 230 by about 5°.

FIG. 2D shows deviations of the calculated phase φ_{TX}_calc from an actual phase φ_{TX} for multiple phases φ_{TX}. The abscissa of FIG. 2D shows the phase φ_{TX} in degree. The ordinate shows the deviation of the calculated phase φ_{TX}_calc from the actual phase φ_{TX} in degree.

Three deviation curves 302, 304 and 306 corresponding to three different frequencies 76 GHz, 79 GHz and 81 GHz are shown in FIG. 2D. For each frequency, a specific deviation curve is observed with each deviation curve being different from deviation curves of other frequencies. For the deviation curve 302, deviations of more than four degrees can be observed resulting in a maximum deviation for all of the three frequencies of more than four degrees.

Examples described herein address the above described deviations resulting from a non-ideal test phase shifter 40 by applying a set of non-uniformly distributed values to calculate first-order harmonic information in an operation acting on the set of measurement samples 204. In the set of non-uniformly distributed values, a difference between at least one pair of adjacent values (e.g., when the set is arranged in an increasing order) differs from a difference between at least one other pair of adjacent values.

In one example, the set of non-uniformly distributed values is a set of non-uniformly distributed sample points applied in a non-uniform discrete Fourier transformation operation acting on the set of measurement samples.

The first-order harmonic information includes in one example the first-order harmonic result of a non-uniform discrete Fourier transformation. The first-order harmonic result corresponds to a fundamental oscillation also referred as first harmonic or Bin 1.

Similar to the uniform Fourier transformation, the first-order harmonic information obtained from the non-uniform discrete Fourier transformation may include a complex-valued first-order harmonic information having a real part and an imaginary part. The phase information related to the respective RF transmission channel can be derived from the real and imaginary part of the complex-valued first-order harmonic information. For example, the phase φ_{TX} of the transmit signal can be derived by calculating or estimating the inverse tangent of (Im(z1)/Re(z1)) which may according to some examples correspond to arctan 2(Im(z1),Re (z1)).

In one example, the set of non-uniformly distributed values may be based on a modification of a uniformly distributed set of predetermined target phase values. The modification may for example include adding or subtracting a modification phase value to at least one target phase value of the set of uniformly distributed set of target phase values. The set of non-uniformly distributed values may in one example include the values φ_{PPM}(i)=φ_{PPM_target}(i)+φ_{PPM_modif}(i) with φ_{PPM_target}(i)=360° i/N, i being an integer from 0 to N−1 and φ_{PPM_modif}(i) being a modification value associated with the target phase value φ_{PPM_target}(i). In one example, all of the modification values φ_{PPM_modif}(i) may have a value in a range between −10° and +10°. In a further example, all of the modification values φ_{PPM_modif}(i) may have a value in a range between −5° and +5°.

According to one example, the set of non-uniformly distributed values may be predetermined information. The predetermined information may be derived from measurements of the actual phases applied by the test phase shifter 40. For example the actual applied phases for each target phase setting may be measured and used for determining the set of non-uniformly distributed values. Measurements of the actual phases applied by the test phase shifter 40 may in some examples include measurements at different frequencies. Measurements of the actual phases applied by the test phase shifter 40 may for example include external measurement equipment. In other examples, the non-uniformly distributed values may be determined based on a simulation of the RF transmission channels 12-1 to 12-4 and/or other circuits of the RF device 10.

A linear optimization may be used for the post processing to generate the non-uniformly distributed values. The optimization criteria may for example include the root mean square error (RMS error) of an external measured phase minus the phase measured by using the above described non-uniformly distributed values for a given frequency.

In one example, the non-uniformly distributed values may be determined in an iterative process. In one example one or more of an initial set of values may be varied and a result of one or more higher-order bins (bins of order two or more) may be used as an optimization criteria to determine the non-uniformly distributed values.

The result of applying non-uniformly distributed values as sample points in a non-uniform discrete Fourier transformation operation (sometimes also referred to as non-equidistant discrete Fourier transformation) can be observed from FIG. 2C. Reference number 231 indicates the result (illustrated as a diamond symbol) of a non-uniform discrete Fourier transformation on the example of FIG. 2C. It can be seen that the determined phase merely deviates (in this example by 0.1°) from the correct phase

FIG. 3A shows results of applying non-uniformly distributed values as sample points in a non-uniform discrete Fourier transformation operation for varying frequencies. For each frequency, a set of non-uniformly distributed values assigned to this frequency. Each frequency FIG. 3A is based on the error profile for the non-uniformly distributed sample points from FIG. 2B. The raw measurement samples are not shown in FIG. 3A. FIG. 3A shows deviations between an actual transmit phase and a calculated transmit phase for multiple phase settings of the transmit phase shifter 20. The abscissa of FIG. 3A shows the respective phase setting of the transmit phase shifter 20 and the ordinate of FIG. 3A shows the deviation between an actual transmit phase (as measured using external equipment) and a calculated transmit phase. The calculated transmit phases are calculated by applying the set of non-uniformly distributed values assigned to the respective frequency for different phase settings of the transmit phase shifter 20. In other words, for one frequency (e.g., 76 GHz) the same set of non-uniformly distributed values as determined from FIG. 2B is used for different phase settings of the transmit phase shifter 20. FIG. 3A shows a deviation curve 308 corresponding to a frequency of 76 GHz, a deviation curve 310 corresponding to a frequency of 79 GHz and a deviation curve 312 corresponding to a frequency of 81 GHz. The transmit power was set to 13 dBm.

It can be observed that the maximum deviation for all phase settings of the transmit phase shifter 20 is reduced to about +/−1 degree for all of the three deviation curves 308, 310 and 312 by using the non-uniformly distributed values. This is a significant improvement compared to the maximum deviation obtained in FIG. 2D of more than 4 degree for all of the three frequencies.

In some examples, the set of non-uniformly distributed values may be applied in operations other than Fourier transformations to determine the phase information related to the RF channel. For example, the set of non-uniformly distributed values may be applied as sample points in a curve fitting operation which fits the set of measurement samples to the expected first-order harmonic function cos(φ_{PPM}−φ_{TX}) with φ_{TX} being the fitting parameter. In this case the first-order harmonic information is the phase offset φ_{TX} of the first order harmonic function cos(φ_{PPM}−φ_{TX}) determined by the fitting which directly corresponds to the phase information related to the RF channel.

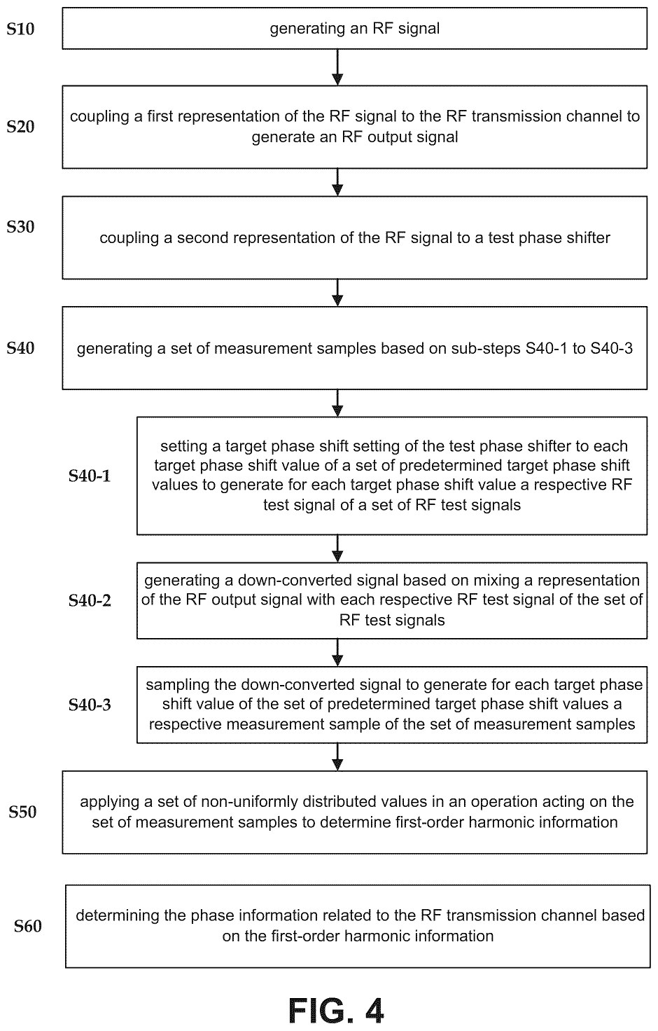

FIG. 4 shows a flow chart diagram of a method for determining phase information related to an RF transmission channel according to one example. In S 10, an RF signal is generated, for example the RF signal 25 generated by the LO signal generator 18 shown in FIG. 1. In S20, a first representation of the RF signal is coupled to the RF transmission channel to generate an RF output signal. Coupling may be achieved for example through the first coupler 14 and the second coupler 16.

In S30, a second representation of the RF signal is coupled to a test phase shifter, for example through the first coupler 14 shown in FIG. 1. In S40, a set of measurement samples is generated using the sub-steps S40-1 to S40-3. S40-1 is a setting of a target phase shift of the test phase shifter to each target phase shift value of a set of predetermined target phase shift values to generate a respective RF test signal for each target phase shift value. In S40-2, a down-converted signal is generated based on mixing a representation of the RF output signal with each respective RF test signal of the set of RF test signals. In S40-3, the down-converted signal is sampled to generate for each target phase shift value of the set of target phase shift values a respective measurement sample of the set of measurement samples. In S50, a set of non-uniformly distributed values is applied in an operation acting on the set of measurement samples to determine first-order harmonic information. The operation acting on the set of measurement samples may be a mathematical operation such as a discrete Fourier transformation or a curve fitting. The non-uniformly distributed values may be used as sample points in the operation. In S60, the phase information related to the RF transmission channel is determined based on the first-order harmonic information.

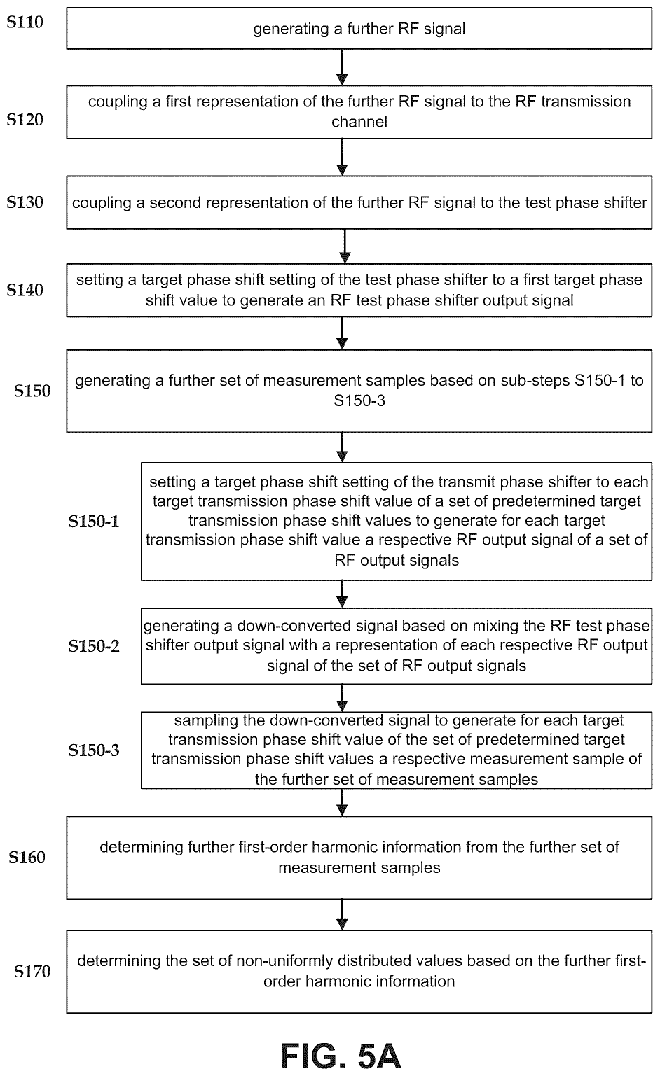

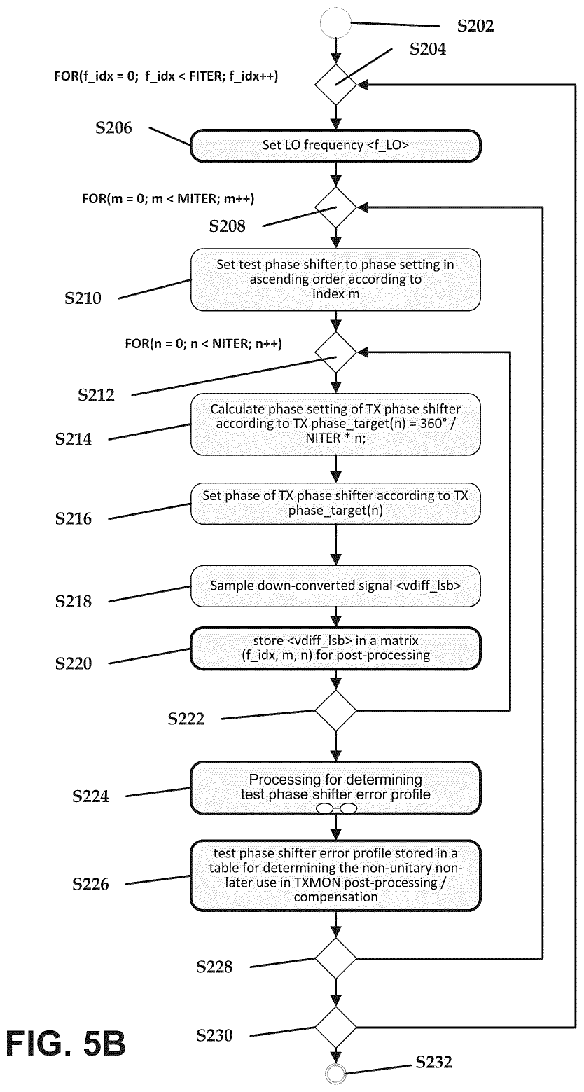

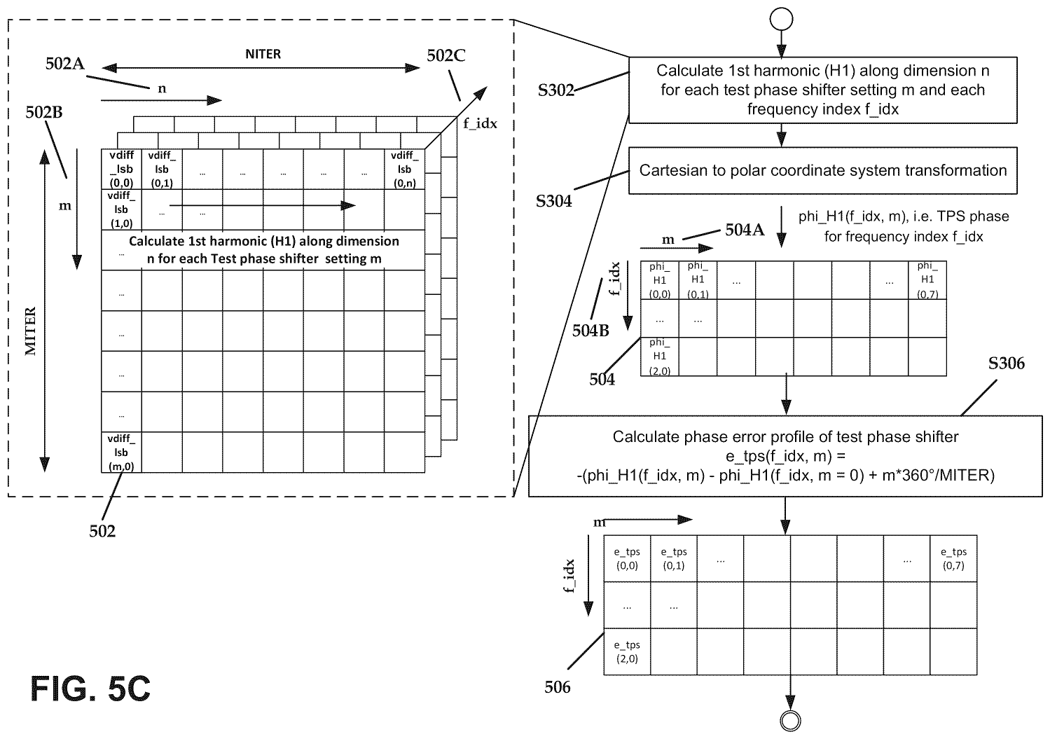

Referring now to FIG. 5A, a method of determining the non-uniformly distributed values will be described. The method may be used in a pre-phase prior to the method described in FIG. 4. The method can be used during an in-field operation of the RF device 10. The method is based on generating further measurement samples by rotating the phase settings of the transmit phase shifter 20 for a respective setting of the test phase shifter 40.

In a step S110, a further RF signal is generated. A first representation of the further RF signal is coupled to the RF transmission channel, S120, and a second representation of the further RF signal is coupled to the test phase shifter 40, S130. The target phase shift setting of the test phase shifter 40 is set to a first target phase shift value to generate an RF test phase shifter output signal, S150. A further set of measurement samples is generated based on the sub-steps 150-1 to 150-3. In sub-step 150-1, a target phase shift setting of the transmit phase shifter is set to each target transmission phase shift value of a set of predetermined target transmission phase shift values to generate for each target transmission phase shift value a respective RF output signal of a set of RF output signals. In S150-2, a down-converted signal is generated based on mixing the RF test phase shifter output signal with a representation of each respective RF output signal of the set of RF output signals. The down-converted signal (which may be substantially a DC-signal) is sampled to generate for each target transmission phase shift value of the set of predetermined target transmission phase shift values a respective measurement sample of the further set of measurement samples, S150-3. Then, in step 160, further first-order harmonic information is determined from the further set of measurement samples. An error of the phase setting to the first target phase shift value by the test phase shifter 40 can be estimated based on the further first-order harmonic information. Then, in S170, the set of non-uniformly distributed values is determined based on the further first-order harmonic information.

In one example, the steps S110 to S160 are repeated such that the target phase shift setting of the test phase shifter 40 is set in S140 to each target phase shift value of the set of target phase shift values. In one implementation, the set of target phase shift settings includes all possible target phase shift settings of the test phase shifter 40. Accordingly, by repeating the steps S110 to S160, a set of further first-order harmonic information is generated where each further first-order information is associated with an error estimate of the respective target phase shift value of the set of target phase shift values. The set of first-order harmonic information indicates the respective phase errors of the test phase shifter 40 when applying each target phase setting.

Furthermore, the steps S110 to S160 can be repeated to change the frequency of the RF signal to each frequency value of a plurality of frequency values. This allows to determine the set of first-order harmonic information for each frequency value of the plurality of frequency values and therefore to obtain an estimate of the respective phase errors for each respective frequency value.

With respect to FIGS. 5B and 5C, a process flow diagram for determining an error profile of a test phase shifter for multiple frequencies is explained in more detail. The process flow is based on nested iterations.

The process flow diagram starts with starting point S202. In S204, the frequency within a frequency iteration is determined based on an index f_idx associated with a respective frequency of the RF signal 25. The frequency iteration starts with the frequency value assigned to the index f_idx=0 and ends with the frequency value assigned to the index f_idx=FITER−1, where FITER is the total number of frequency iterations. In S206, the local oscillator 18 is controlled to generate the RF signal 25 with the respective frequency indicated by f_idx.

In S208, the phase setting value for the test phase shifter 40 within a test phase shifter iteration is determined by an index m. The target phase setting within the test phase shifter iteration starts with the target phase shift value assigned to index m=0. After each iteration loop in the test phase shifter iteration, the index m is increased by one until the iteration ends with the target phase shift value assigned to index m=MITER−1 with MITER being the total number of iteration loops within one test phase shifter iteration. Typically, MITER is equal to the number of phase settings possible in the test phase shifter and each index m corresponds to one possible target phase setting. In each test phase shifter iteration loop, the test phase shifter 40 is set to the target phase shift value assigned to the respective index m, S210.

Next, in S212, the transmission target phase value is determined based on an index n used in the transmit phase shifter iteration. The transmit phase shifter index n starts with n=0 and is increased by one after each iteration up to NITER−1, with NITER being the total number of iterations in the transmit phase shifter iteration. The target transmission phase shift value of the transmit phase shifter 20 is calculated in S214 from the current index n by TX target(n)=360° n/NITER. Accordingly, the transmission target phase shift value is rotated from 0 to 360° in regular steps of 360°/NITER. In S216 the phase of the transmit phase shifter 20 is set according to the transmission target phase shift value corresponding to the index n. In S218, the down-converted signal is sampled and the sampled value <vdifff_lsb> is stored in a matrix for each value of f_idx, m and n, S220.

At process branch 222, the transmission phase shifter iteration loops back to S212 to increase the parameter n and start a new transmission phase shifter iteration loop until the transmit phase iteration is completed. After completion of the transmit phase iteration, the measurement samples stored during one complete transmit phase iteration represent a set of measurement samples of size NITER. In S224, the further set of measurement samples is processed in order to determine the respective test phase shifter error profile as will be described in more detail in FIG. 5C.

In S226 the error profile for the respective phase setting of the test phase shifter 40 is stored in a table. The stored error profile is later used to determine the set of non-uniformly distributed values used in the monitoring or calibrating of the transmit phase shifter 20. After S226, the process proceeds to process branch S228 and the test phase shifter iteration loops back to S208 for increasing the index m by one in order to set the test phase shifter 40 to a new phase setting and start in S212 a new transmit phase shifter iteration loop. After the test phase shifter iteration is completed (MITER−1), the process proceeds to branch S230 in order to loop back to S204 for setting a new frequency value. After the frequency iteration is completed, the process proceeds to S232 at which the process is completed.

Referring now to FIG. 5C, the processing of the measurement samples for determining a test phase shifter error profile (S224) will be described in more detail. FIG. 5C shows the three dimensional matrix 502 of measurement samples which is filled during the above described iterations. After each transmit phase shifter iteration loop, a respective measurement sample <vdiff_lsb>(f_idx,m,n) is stored in the matrix 502. Note that the measurement sample <vdiff_lsb>(f_idx,m,n) is shown in FIG. 5C with indexes (m, n) omitting the frequency index (f_idx) for the sake of simplicity. After a respective transmit phase shifter iteration is completed, a corresponding row along the n-axis 502A is completely filled with NITER measurement samples. Each row along the n-axis constitutes a respective further set of measurement samples <vdiff_lsb>(F_idx,m,n). Furthermore, as the process cycles through the test phase shifter iteration loops, the matrix gets filled along the m-axis 502B. As the process cycles through the frequency iteration loops, the matrix gets filled along the f_idx axis 502C.

For each completely filled row of measurement samples <vdiff_lsb>(f_idx,m,n) (n=0 to NITER−1) along the n-axis 502A, a first-order harmonic information of this row is calculated in S302. The first-order harmonic information H1 may be calculated by applying an FFT processing or a Goertzel filtering to the respective row. The resulting first-order harmonic information H1 (f_idx, m) is transformed from a Cartesian system to a polar coordinate system, S304. After transforming into the polar coordinate system, the first-order harmonic information is represented by an amplitude A(f_idx, m) and an angle Phi(f_idx, m)). The angle Phi(f_idx, m) represents the phase of the test phase shifter output signal relative to the transmission output signal for each phase setting of the test phase shifter 40 corresponding to the index m and for each frequency corresponding to the index f_idx. Each angle Phi(f_idx, m) is stored in a table 504. As the process cycles through each test phase shifter iteration loop, the table 504 gets filled along an m-axis 504A. As the process cycles through the frequency iteration loops, the table 504 gets filled along an f_idx axis 504B.

From the table 504, an error profile of the test phase shifter 40 can be calculated. In S306, the error profile of the test phase shifter 40 is calculated by e_tps(f_idx, m)=−(phi_H1(f_idx, m)−phi_H1(f_idx, m=0)+m*360°/MITER). It is to be noted that the error profile is in this example normalized such that the error of index m=0 (0° target setting) is obtained to be zero. Normalizing to other values of the index m is also possible as only the relative phase deviations are relevant.

It is further to be noted that the term m*360°/MITER represents the target phase settings of the test phase shifter 40 which are uniformly distributed between 0 and 360 degrees for m=0 to MITER−1. Accordingly, the error profile e_tps(f_idx, m) of the test phase shifter 40 stored in table 506 indicates for each target phase shift value corresponding to the index m the target phase setting including an estimated phase correction. The set of non-uniformly distributed values can be directly derived from the error profile stored in table 506. If the frequency is close to one of the frequencies corresponding to f_idx, the set of non-uniformly distributed values may correspond to the respective row in table 506. Alternatively or additional, the set of non-uniformly distributed values may be derived by averaging or interpolating over all frequencies for each respective m, for example by calculating an arithmetic mean value or a weighted arithmetic mean value.

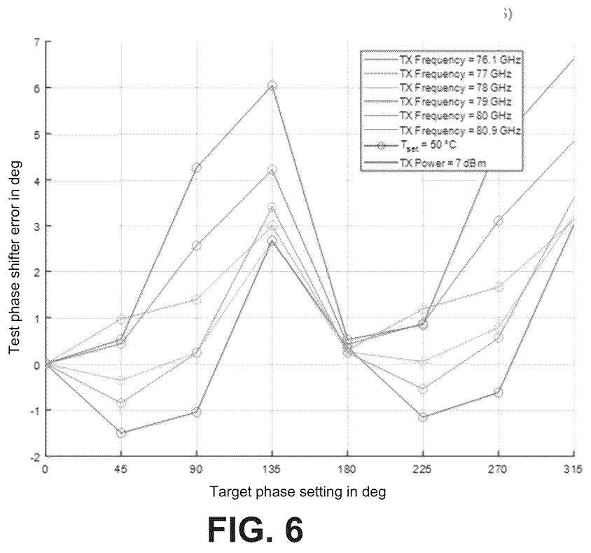

FIG. 6 shows example error estimates versus target phase settings of the test phase shifter 40 calculated using the above described process for various frequencies. The ordinate of FIG. 6 shows for multiple frequencies (76.1 GHz, 77 GHz, 78 GHz, 79 GHz, 80 GHz and 80.9 GHz) the test phase shifter error=phi_H1(f_idx, m)−phi_H1(f_idx, m=0) in degrees for the various target phase settings in degrees. Due to the normalization, the test phase shifter error for 0° degree is obtained to be 0°.

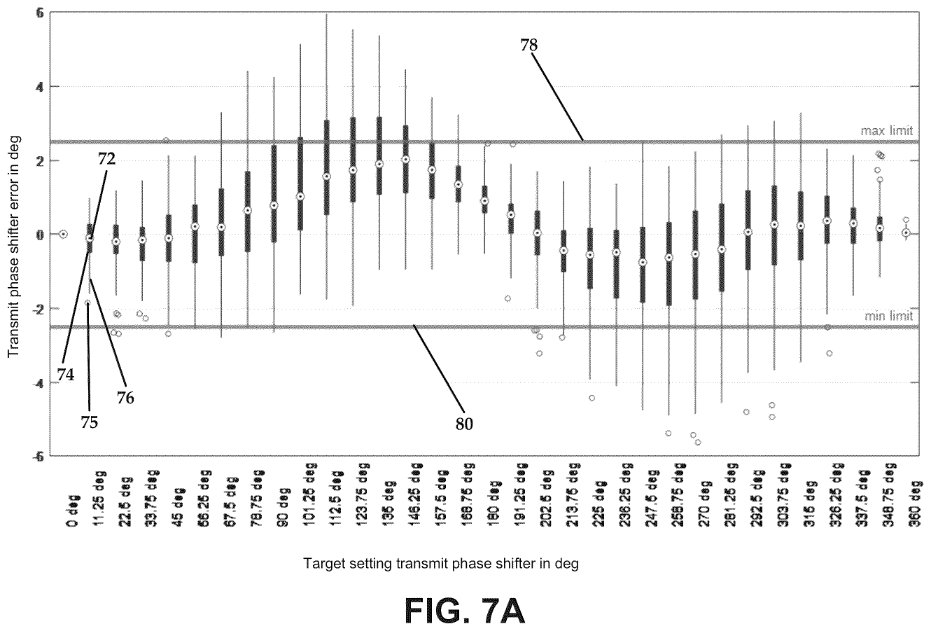

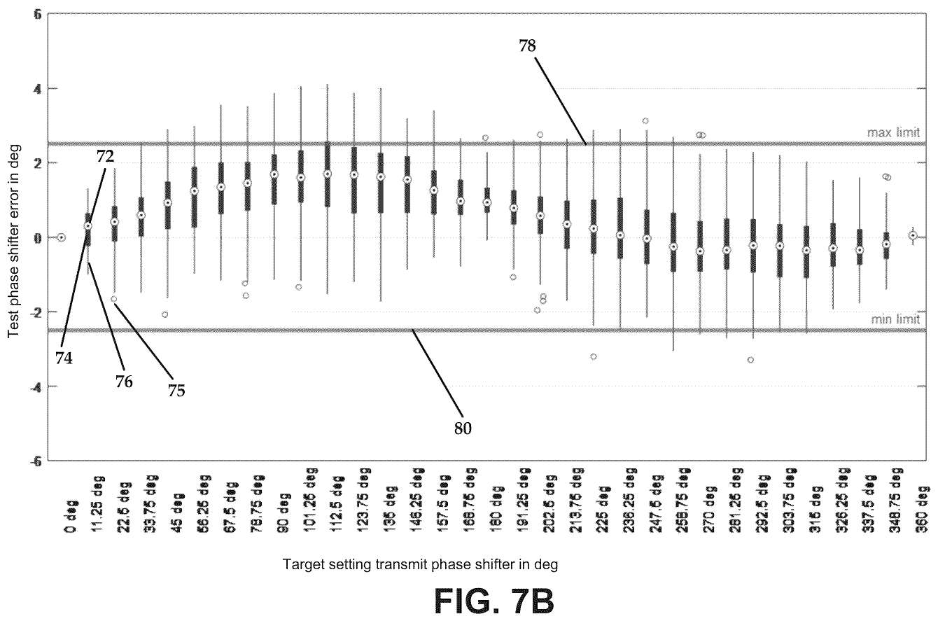

FIGS. 7A and 7B show in box plots how the above described methods of determining the set of non-uniformly distributed values and using the set of non-uniformly distributed values in a transmit channel calibration can be used to improve the phase setting of the transmit phase shifter 20. FIG. 7A shows measured phase error data of a transmit channel versus various target phase settings of the transmit phase shifter 20 using a conventional calibration. FIG. 7A shows for each target phase setting a box 74 with 25th and 75th percentiles, respectively. The distance between the top and bottom of each box 74 is the interquartile range. Reference number 72 shows the median of each box 74, and, if the median is not centered, the sample skewness can be observed. For each box, whiskers 76 extending from the end of the interquartile range to the furthest observation within the whisker length (whisker length being the interquartile range multiplied by 1.5) are shown. Observations outside of the whiskers (outliers) are shown with reference number 75. A desired region is indicated by a maximum limit 78 and a minimum limit 80. It can be observed that respective boxes 74 exceed the maximum limit 78 for multiple transmission target phase settings (e.g., between 101.25 deg and 146.25 deg).

FIG. 7B shows measured phase error data of the transmit channel versus various target phase settings of the transmit phase shifter 20 using the process described with respect to FIGS. 5A to 5C in the process described with respect to FIGS. 1 to 4. Similar to FIG. 7A, FIG. 7B shows for each target phase setting a median 72, a box 74 and a whiskers 76 and a desired region bound by a maximum limit 78 and a minimum limit 80. The boxes 74 can be observed to be within the maximum limit 78 and minimum limit 80 showing the improvement of the phase error of a transmit channel achieved with the above described concept.

The above described concept of using non-uniformly distributed values allows a more flexible and accurate approach which may address not only errors introduced by the test phase shifter 40 but also errors that are introduced by variations in the time of arrival of the RF test signal 29 and the first representation 34 of the RF output signal 32 at the test mixer 38. Such variations can be caused for example when different frequencies are used or temperature changes. The concept allows to compensate for such variations by applying the set of non-uniformly distributed values based on the operating conditions such as on the frequency of operation, temperature or static offsets resulting for example from manufacturing tolerances. The set of non-uniformly distributed values may in one example therefore be selected based on operation parameters such as a frequency band of operation or a temperature within the RF device 10 or predetermined information related to static offsets.

In case a signification variation in the signal delay exists between transmission channels 12-1 to 12-4, the set of non-uniformly distributed values may also be selected dependent on the transmission channel.

The improvements resulting from this concept can be easily implemented as the applying of the non-uniformly distributed values can be fully implemented in firmware.

In addition to the above described examples, the following examples are disclosed.

Example 1 is a method for determining phase information related to a radio frequency, RF, transmission channel, the method comprising:
generating an RF signal,
coupling a first representation of the RF signal to the RF transmission channel to generate an RF output signal,
coupling a second representation of the RF signal to a test phase shifter,
generating a set of measurement samples, the set of measurement samples being generated based on:
setting a target phase shift setting of the test phase shifter to each target phase shift value of a set of predetermined target phase shift values to generate for each target phase shift value a respective RF test signal of a set of RF test signals,
generating a down-converted signal based on mixing a representation of the RF output signal with each respective RF test signal of the set of RF test signals,
sampling the down-converted signal to generate for each target phase shift value of the set of predetermined target phase shift values a respective measurement sample of the set of measurement samples,
applying a set of non-uniformly distributed values in an operation acting on the set of measurement samples to determine first-order harmonic information, and
determining the phase information related to the RF transmission channel based on the first-order harmonic information.

Example 2 is the method according to example 1, wherein the operation acting on the set of measurement samples is at least one of a non-uniform Discrete Fourier Transformation or a curve fitting operation.

Example 3 is the method according to example 1 or 2, wherein each value of the set of non-uniformly distributed values is associated with a respective target phase shift value of the pset of predetermined target phase shift value.

Example 4 is the method according to any of the preceding examples, wherein the set of non-uniformly distributed values represents sample points of a non-uniform Discrete Fourier Transformation or sample points of a curve fitting operation.

Example 5 is the method according to any of the preceding examples, further comprising: determining the set of non-uniformly distributed values based on frequency information indicating a frequency of the RF signal.

Example 6 is the method according to any of the preceding examples, further comprising: determining the set of non-uniformly distributed values based on temperature information.

Example 7 is the method according to any of the preceding examples, wherein the set of non-uniformly distributed values is determined at least partially on predetermined data.

Example 8 is the method according to example 7, wherein the predetermined data is determined based on at least one of a measurement of a phase of the RF output signal or a simulation of the RF transmission channel.

Example 9 is the method according to any of the preceding examples wherein generating an RF signal, coupling a first representation of the RF signal to the RF transmission channel to generate an RF output signal, coupling a second representation of the RF signal to a test phase shifter, generating a set of measurement samples, applying the set of non-uniformly distributed values and determining the phase information are performed in one single semiconductor chip.

Example 10 is the method according to any of the preceding examples, wherein a distribution of the set of non-uniformly distributed values is dependent on at least one of a phase error of the test phase shifter estimated for each target phase shift value or a phase error between the representation of the RF output signal and each respective RF test signal.

Example 11 is the method according to any of the preceding examples, wherein the set of target phase shift values is uniformly distributed.

Example 12 is an RF device comprising:
a local oscillator to generate an RF signal,
an RF transmission channel configured to receive a first representation of the RF signal and to generate an RF output signal based on the first representation of the RF signal,
a test phase shifter to receive a second representation of the RF signal, wherein the test phase shifter is configured to generate a set of RF test signals based on applying a phase shift to the second representation of the RF signal in accordance with a set of predetermined target phase shift values,
a mixer to generate a set of down-converted signals based on mixing a first representation of the RF output signal with each respective RF test signal of the set of RF test signals,
a sampler to sample each down-converted signal of the set of down-converted signals to generate for each target phase shift value of the set of target phase shift values a respective measurement sample of a set of measurement samples,
a processing device to apply, in an operation acting on the set of measurement samples, a set of non-uniformly distributed values to determine first-order harmonic information and to determine a phase information related to the RF transmission channel based on the first-order harmonic information.

Example 13 is the RF device according to example 12, wherein the processing device is configured to apply at least one of a non-uniform Discrete Fourier Transformation operation or a curve fitting operation on the set of measurement samples.

Example 14 is the RF device according to examples 12 or 13, wherein the set of target phase shift values is uniformly distributed and each value of the set of non-uniformly distributed values is associated with a respective target phase shift value of the set of target phase shift value.

Example 15 is the RF device according any of examples 12 to 14, wherein the processing device is configured to apply the set of non-uniformly distributed values as sample points in a non-unitary Discrete Fourier Transformation or to apply the set of non-uniformly distributed values as sample points in a curve fitting operation.

Example 16 is the RF device according to any of examples 12 to 15, wherein the processing device is further configured to determine the set of non-uniformly distributed values based on frequency information indicating a frequency of the RF signal.

Example 17 is the RF device according to any of examples 12 to 16, wherein the processing unit is further configured to determine the set of non-uniformly distributed values based on temperature information.

Example 18 is the RF device according to any of examples 12 to 17, wherein the processing device is further configured to determine the set of non-uniformly distributed values based on predetermined data.

Example 19 is the RF device according to example 18, wherein the processing unit is further configured to determine the set of non-uniformly distributed values based on at least one of:
predetermined measurement data from a testing operation of an RF device comprising the transmission channel,
predetermined measurement data from a calibration operation of the RF device, or
predetermined measurement data from a simulation of the RF device or transmission channel.

Example 20 is the RF device according to any of examples 12 to 18, wherein the RF device is implemented on a single semiconductor chip.

Although specific examples have been illustrated and described herein, it will be appreciated by those of ordinary skill in the art that a variety of alternate and/or equivalent implementations may be substituted for the specific examples shown and described without departing from the scope of the present implementation. This application is intended to cover any adaptations or variations of the specific examples discussed herein. Therefore, it is intended that this implementation be limited only by the claims and the equivalents thereof.

It should be noted that the methods and devices including its preferred implementations as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the implementation and are included within its spirit and scope. Furthermore, all examples and implementations outlined in the present document are principally intended expressly to be only for explanatory purposes to help the reader in understanding the principles of the proposed methods and systems. Furthermore, all statements herein providing principles, aspects, and implementations of the implementation, as well as specific examples thereof, are intended to encompass equivalents thereof.

1. A method for determining phase information related to a radio frequency (RF) transmission channel, the method comprising:
generating an RF signal,
coupling a first representation of the RF signal to the RF transmission channel to generate an RF output signal,
coupling a second representation of the RF signal to a test phase shifter,
generating a set of measurement samples, the set of measurement samples being generated based on:
setting a target phase shift setting of the test phase shifter to each target phase shift value of a set of predetermined target phase shift values to generate, for each target phase shift value, a respective RF test signal of a set of RF test signals,
generating a down-converted signal based on mixing a representation of the RF output signal with each respective RF test signal of the set of RF test signals, and
sampling the down-converted signal to generate, for each target phase shift value of the set of predetermined target phase shift values, a respective measurement sample of the set of measurement samples,
applying a set of non-uniformly distributed values in an operation acting on the set of measurement samples to determine first-order harmonic information, and
determining the phase information related to the RF transmission channel based on the first-order harmonic information.

2. The method according to claim 1, wherein the operation acting on the set of measurement samples is at least one of a non-uniform Discrete Fourier Transformation or a curve fitting operation.

3. The method according to claim 1, wherein each value of the set of non-uniformly distributed values is associated with a respective target phase shift value of the set of predetermined target phase shift value.

4. The method according to claim 1, wherein the set of non-uniformly distributed values represents sample points of a non-uniform Discrete Fourier Transformation or sample points of a curve fitting operation.

5. The method according to claim 1, further comprising: determining the set of non-uniformly distributed values based on frequency information indicating a frequency of the RF signal.

6. The method according to claim 1, further comprising:
determining the set of non-uniformly distributed values based on temperature information.

7. The method according to claim 1, wherein the set of non-uniformly distributed values is determined at least partially on predetermined data.

8. The method according to claim 7, wherein the predetermined data is determined based on at least one of a measurement of a phase of the RF output signal or a simulation of the RF transmission channel.

9. The method according to claim 1, wherein generating an RF signal, coupling a first representation of the RF signal to the RF transmission channel to generate an RF output signal, coupling a second representation of the RF signal to a test phase shifter, generating a set of measurement samples, applying the set of non-uniformly distributed values and determining the phase information are performed in one single semiconductor chip.

10. The method according to claim 1, wherein a distribution of the set of non-uniformly distributed values is dependent on at least one of a phase error of the test phase shifter estimated for each target phase shift value or a phase error between the representation of the RF output signal and each respective RF test signal.

11. The method according to claim 1, wherein the set of target phase shift values is uniformly distributed.

12. The method according to claim 1, further comprising:
determining the set of non-uniformly distributed values, wherein determining the set of non-uniformly distributed values comprises:
generating a further RF signal,
coupling a first representation of the further RF signal to the RF transmission channel,
coupling a second representation of the further RF signal to the test phase shifter,
setting a target phase shift setting of the test phase shifter to a first target phase shift value of the set of predetermined target phase shift values to generate an RF test phase shifter output signal,
generating a further set of measurement samples, the further set of measurement samples being generated based on:
setting a target phase shift setting of a transmission phase shifter in the RF transmission channel to each target transmission phase shift value of a set of predetermined target transmission phase shift values to generate, for each target transmission phase shift value, a respective RF output signal of a set of RF output signals,
generating a down-converted signal based on mixing the RF test phase shifter output signal with a representation of each respective RF output signal of the set of RF output signals, and
sampling the down-converted signal to generate, for each target transmission phase shift value of the set of predetermined target transmission phase shift values, a respective measurement sample of the further set of measurement samples,
determining further first-order harmonic information from the further set of measurement samples, and
determining the set of non-uniformly distributed values based on the further first-order harmonic information.

13. The method according to claim 12, further comprising:
repeating the setting of a target phase shift setting of the test phase shifter in order to set the target phase shift setting of the test phase shifter to each target phase shift value of the set of predetermined phase shift values,
for each target phase shift value of the set of predetermined phase shift values set by the test phase shifter, repeating the generating of a further set of measurement samples in order to generate a set of further sets of measurement samples, and
determining the set of non-uniformly distributed values based on determining for each further set of the set of further sets of measurement samples a respective further order harmonic information of a set of further first-order harmonic information.

14. The method according to claim 13, further comprising
setting a frequency of the further RF signal to each frequency value of a plurality of frequency values,
repeating the setting of a target phase shift setting of the test phase shifter in order to set the target phase shift setting of the test phase shifter to each target phase shift value of the set of predetermined target phase shift values for each frequency value of the plurality of frequency values,
for each frequency value of the plurality of frequency values and for each value of the plurality of values set by the test phase shifter, repeating the generating of a further set of measurement samples in order to generate, for each frequency value of the plurality of frequency values, the set of further sets of measurement samples, and
determining the set of non-uniformly distributed values based on determining for each frequency value a respective set of further first-order harmonic information.

15. A radio frequency (RF) device comprising:
a local oscillator to generate an RF signal,
an RF transmission channel configured to receive a first representation of the RF signal and to generate an RF output signal based on the first representation of the RF signal,
a test phase shifter to receive a second representation of the RF signal, wherein the test phase shifter is configured to generate a set of RF test signals based on applying a phase shift to the second representation of the RF signal in accordance with a set of predetermined target phase shift values,
a mixer to generate a set of down-converted signals based on mixing a first representation of the RF output signal with each respective RF test signal of the set of RF test signals,
a sampler to sample each down-converted signal of the set of down-converted signals to generate, for each target phase shift value of the set of target phase shift values, a respective measurement sample of a set of measurement samples,
a processing device to apply, in an operation acting on the set of measurement samples, a set of non-uniformly distributed values to determine first-order harmonic information and to determine a phase information related to the RF transmission channel based on the first-order harmonic information.

16. The RF device according to claim 15, wherein the processing device is configured to apply at least one of a non-uniform Discrete Fourier Transformation operation or a curve fitting operation on the set of measurement samples.

17. The RF device according to claim 15, wherein the set of target phase shift values is uniformly distributed and each value of the set of non-uniformly distributed values is associated with a respective target phase shift value of the set of target phase shift value.

18. The RF device according to claim 15, wherein the processing device is configured to apply the set of non-uniformly distributed values as sample points in a non-unitary Discrete Fourier Transformation or to apply the set of non-uniformly distributed values as sample points in a curve fitting operation.

19. The RF device according to claim 15, wherein the processing device is further configured to determine the set of non-uniformly distributed values based on frequency information indicating a frequency of the RF signal.

20. The RF device according to claim 15, wherein the processing unit is further configured to determine the set of non-uniformly distributed values based on temperature information.

21. The RF device according to claim 15, wherein the processing device is further configured to determine the set of non-uniformly distributed values based on predetermined data.

22. The RF device according to claim 21, wherein the processing unit is further configured to determine the set of non-uniformly distributed values based on at least one of:
predetermined measurement data from a testing operation of the RF device comprising the transmission channel,
predetermined measurement data from a calibration operation of the RF device, or
predetermined measurement data from a simulation of the RF device or transmission channel.

23. The RF device according to claim 15, wherein the RF device is implemented on a single semiconductor chip.

24. The RF device according to claim 15, further comprising a transmission phase shifter in the transmission channel configured to apply a target phase setting to a respective RF signal received by the transmission channel, wherein during a pre-phase:
the local oscillator is configured to generate a further RF signal,
the transmission channel is configured to receive a first representation of the further RF signal
the transmission phase shifter is controlled to set the target phase shift setting to each target transmission phase shift value of a set of predetermined target transmission phase shift values in order to generate, for each target transmission phase shift value, a respective RF output signal of a set of RF output signals,
the test phase shifter is controlled to set the target phase shift setting of the test phase shifter to each target phase shift value of the set of target phase shift values in order to generate a set of RF test phase shifter output signals,
the mixer is configured to generate for each target transmission phase shift value of the set of predetermined target transmission phase shift values and for each target phase shift value of the set of predetermined target phase shift values a down-converted signal based on mixing each respective RF test phase shifter output signal of the set of RF test phase shifter output signals with a respective representation of each RF output signal of the set of RF output signals,
the sampler is configured to generate a set of further sets of measurement samples by sampling an output signal of the mixer in order to generate, for each target transmission phase shift value of the set of predetermined target transmission phase shift values and for each target phase shift value of the set of predetermined target phase shift values, a respective measurement sample of the set of further sets of measurement samples,
wherein each measurement sample of a respective further set of measurement samples is associated with a respective target transmission phase shift value of the set of predetermined target transmission phase shift values and wherein each respective further set of measurement samples is associated with a respective target phase shift value of the set of predetermined target phase shift values, and
the processing device is configured to determine the set of non-uniformly distributed values based on determining, for each further set of measurement samples of the set of further sets of measurement samples, a respective first-order harmonic information of a set of further first-order information.

25. The RF device according to claim 15, wherein the local oscillator is configured to change the frequency of the further RF signal to each frequency of a plurality of frequencies, and
wherein the processing device is configured to determine the set of further first-order information based on determining a respective set of further first-order information for each frequency of the plurality of frequencies.
